(19) United States
(12) Patent Application Publication
(10) Pub. No.: US 2009/0107975 A1
(43) Pub. Date: Apr. 30, 2009

(54) HEATING UNIT FOR WARMING PALLETS

(76) Inventors: Thomas Caterina, Boise, ID (US); David Naylor, Draper, UT (US)

Correspondence Address: Workman Nydegger;1000 Eagle Gate Tower, 60 East South Temple, Salt Lake City, UT, 84111, US

(21) Appl. No.: 12/258,240

(22) Filed: Oct. 24, 2008

Related U.S. Application Data
(63) Continuation-in-part of application No. 11/835,641, filed on Aug. 8, 2007.
Application No. 11/835,641 is a continuation-in-part of application No. 11/744,163, filed on May 3, 2007.
Application No. 11/744,163 is a continuation-in-part of application No. 11/218,156, filed on Sep. 1, 2005, now Pat. No. 7,230,213.
Application No. 11/218,156 is a continuation-in-part of application No. 11/422,580, filed on Jun. 6, 2006.
Application No. 11/422,580 is a continuation-in-part of application No. 11/218,156, filed on Sep. 1, 2005, now Pat. No. 7,230,213.
Application No. 11/422,580 is a continuation-in-part of application No. 11/344,830, filed on Feb. 1, 2006, now Pat. No. 7,183,524.
Application No. 11/344,830 is a continuation-in-part of application No. 11/218,156, filed on Sep. 1, 2005, now Pat. No. 7,230,213.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.

(51) Int. Cl. H05B 3/34; H05B 1/00

(52) U.S. Cl. 219/213; 219/494; 219/492; 219/528

(57) ABSTRACT

A heating unit for use in heating pallets. The heating unit includes side modules and a lid module. Modules include cover layers. Modules may include a pliable electrical heating element is disposed between the first and the second cover layers and configured to convert electrical energy to heat energy and to distribute the heat energy. The pliable electrical heating element includes a heat generating element for converting electrical current to heat energy and a heat spreading element comprising carbon thermally coupled to the heat generating element. Modules may further include a thermal insulation layer. Modules may include a receiving power connector electrically connected to the heat generating element. Modules may include a seam formed in a fashion that facilitates folding of the modules in a fashion which allows support members to support a module on an edge of the module.

### CROSS-REFERENCE TO RELATED APPLICATIONS

This application is a continuation in part of co-pending U.S. application Ser. No. 11/835,641 filed on Aug. 8, 2007 titled GROUNDED MODULAR HEATED COVER, which is a continuation in part of U.S. patent application Ser. No. 11/744,163 filed May 3, 2007, which is a continuation in part of U.S. patent application Ser. No. 11/218,156 filed Sep. 1, 2005, now U.S. Pat. No. 7,230,213, issued on Jun. 12, 2007. This application is also a continuation in part of co-pending U.S. application Ser. No. 11/422,580 filed on Jun. 6, 2006, titled “A RADIANT HEATING APPARATUS” which claims: priority to U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is a Continuation in Part of U.S. patent application Ser. No. 11/218,156, filed Sep. 1, 2005, now U.S. Pat. No. 7,230,213 issued on Jun. 12, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY HEATED THERMAL COVER; and U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is also a Continuation in Part of U.S. patent application Ser. No. 11,344,830, filed Feb. 1, 2006 now U.S. Pat. No. 7,183,524 issued on Feb. 27, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY HEATED THERMAL COVER; and U.S. Provisional Patent Application 60/688,146 filed Jun. 6, 2005, titled LAMINATE HEATING APPARATUS. U.S. patent application Ser. No. 11/344,830, filed Feb. 1, 2006 now U.S. Pat. No. 7,183,524 issued on Feb. 27, 2007, is also a Continuation in Part of U.S. patent application Ser. No. 11/218,156, filed Sep. 1, 2005, now U.S. Pat. No. 7,230,213 issued on Jun. 12, 2007. Each of the preceding United States patent applications and patents is incorporated herein in its entirety by this reference

### BACKGROUND

### Background and Relevant Art

Changing weather can affect driving surfaces. For example, the expansion and contraction of asphalt paved surfaces during winter months due to cycling of the temperature of the asphalt paved surfaces due to alternating exposure to sun and snow can cause potholes in the asphalt driving surfaces. To fix these potholes, asphalt patch is used, which is combination of oil, gravel, tar, and a number of other materials. To use the asphalt patch, the asphalt patch needs to be maintained above a given temperature to allow it to be properly applied to a pothole. However, cold weather conditions can make maintaining the asphalt patch above the given temperature a challenge. Cities and other municipalities often discard as much as 40% of asphalt patch purchased, because it cannot be maintained at an appropriate temperature.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an exploded view of a pallet warmer; and

FIG. 2 an exploded view of a heating unit for use in a pallet warmer;

### DETAILED DESCRIPTION

Disclosed herein are embodiments of a heating unit for use in pallet warming or other warming applications. In particular, some embodiments may include a heating unit configured to substantially cover the entire outer perimeter of a pallet and items stored on the pallet, including substantially the full height of the pallet and items stored thereon. The heating unit includes a heating element which provides heat and spreads the heat over the surface of at least portions of the heating unit. The heating unit may also include an insulation layer to prevent heat from being lost to an environment external to the pallet.

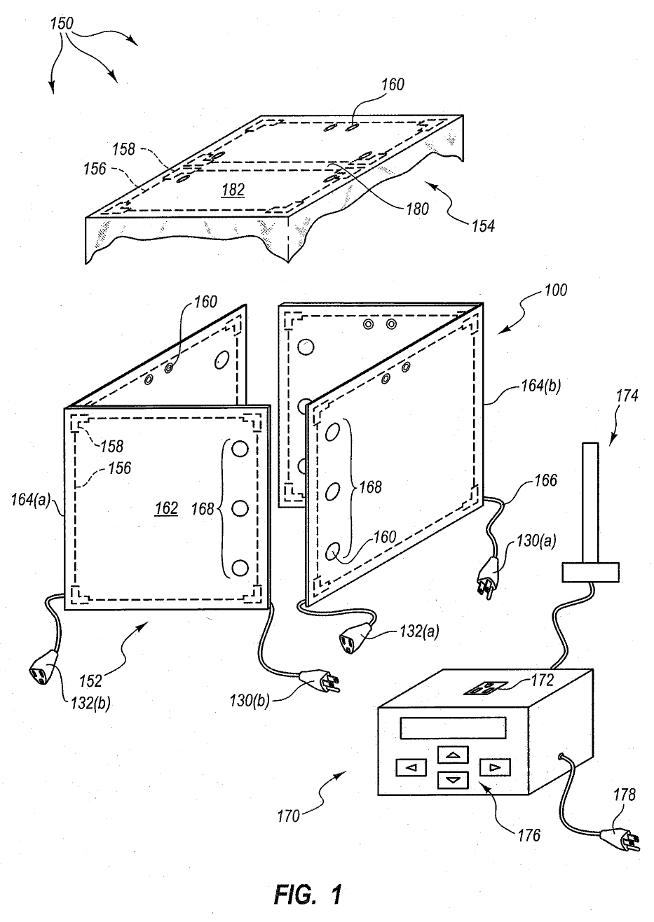

FIG. 1 illustrates one embodiment of a heating unit 150 configured as a pallet warmer. In particular, the heating unit 150 is a modular heating unit including, in this example, three modules. The heating unit 150 includes a heating module 100, a second module 152, and a lid module 154. The heating module 100 and the second module 152 each are designed to be supported on their edges when folded along a crease or seam 164(a) or 164(b) respectively, and to be configured to be coupled together, either securely or without securement, to substantially form the walls of a box. The modules may be fabricated to include the creases 164(a) or 164(b) which allows the modules 152 and 100 to be folded such that the modules 152 and 100 can be supported on their edges in a somewhat stable fashion. In addition, the box formed does not necessarily need to be a box with squared corners emanating from the creases 164(a) and 164(b), but rather, any suitable angles and/or curves can be used.

The seams 164(a) and 164(b) may be formed in a number of different ways, such as by connecting two separate pieces together, or by performing operations on a single continuous piece. Such operations may include various heat welding operations or other appropriate operations. In particular, in some embodiments, the modules 100, 152 and 154 may have an external vinyl covering which may allow for heat welding and heat seams to be formed in the vinyl.

In the example illustrated in FIG. 1, the modules 100, 152, and 154 each include fasteners 160. The fasteners 160 can be used to securely couple the modules 100, 152, and 154 to each other. In some embodiments, the fasteners may be selectively coupleable to allow a panel, such as panel 162, or one of the other panels to be used as a door for accessing items being heated by the heating unit 150. In particular, in some embodiments, the fasteners designated by 168 may be selectively secured using one or more adjustable bungee cords, clips, etc. For more permanent securement, fasteners may be fastened by zip ties, rope, string, wire, or other appropriate fasteners.

The modules 100, 152 and 154 include support members arranged to provide rigidity to the modules 100, 152 and 154. In particular, the modules 100, 152 and 154 include rods 156 shown in phantom and elbows 158 also shown in phantom. The rods 156 can be inserted into hollow elbows 158 to form a support structure. The rods 156 may be secured into the elbows using an appropriate glue or epoxy material. In the example illustrated, the rods 156 are secured into the elbows using Loctite 380, also known as Black Max, available from Henkel Corporation of Düsseldorf, Germany. As will be discussed later herein, the modules 100 and 152 may include a pliable cover and other flexible materials that may not sufficiently support the modules when the modules are supported by their edges. Thus, the support members can act as stiffeners to allow the modules to be better supported when supported by their edges. In one embodiment, the pliable cover may form an envelope that can be used to house the support structure as well as other components such as insulation and heating components as described in more detail below.

The rods 156 may be constructed from materials such as fiberglass, plastic metal or other materials. Similarly, the elbows 158 may be fiberglass, plastic, metal (such as copper, aluminum, steel, etc) or other materials. In one particular embodiment, fiberglass rods 156 are used with copper elbows 158 secured together using Loctite 380.

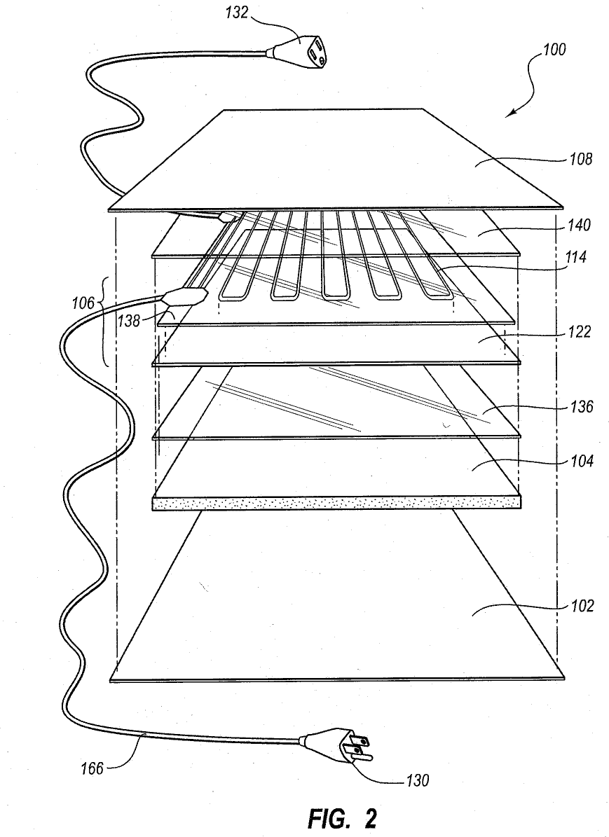

An example of components implemented in one embodiment is illustrated in FIG. 2. These Figures illustrate construction details of the heating module 100 of the heating unit 150 and in some embodiments, the module 152, including materials used to assemble the heating module 100. FIG. 2 illustrates an exploded view illustrating that the heating module 100 of the heating unit 150 includes a first cover layer 102, an insulation layer 104, a heating element 106, and a second cover layer 108. The heating module 100 of the heating unit 150 further includes an incoming electrical connector 130 and an outgoing electrical connector 132. FIG. 1 illustrates that the module 152 includes a receptacle 130(b) that may be plugged into the receptacle 132(a) to obtain power when the module 152 includes active heating elements. Notably, as illustrated in FIG. 1, the module 152 may include a receptacle 132(b) that may be used to distribute power to other modules and/or other heating units.

Some finished embodiments may be manufactured such that the insulation layer 104 and the heating element 106 may be sealed between the first cover layer 102 and the second cover layer 108. Sealing processes and details will be discussed in more detail below. Additionally, some embodiments may include the use of glues, epoxies or other materials to seal various layers of the heating module 100 together. For example, in one embodiment, 30-NF FASTBOND™ contact adhesive available from 3M located in St. Paul, Minn. may be used to glue various layers together.

As described herein, the various components of heating unit 100 may be flexible. To ensure that heating unit 100 and its various components retain their shape and their positions relative to one another, the various components of heating unit 100 can be attached to one another. For example, the various components of heating unit 100 can be glued, bonded, or otherwise held together. Attaching the components of heating unit 100 together helps to prevent the components from moving relative to one another within heating unit 100.

For example, attaching heating element 106 to insulation layer 104 ensures that heating element 106 will stay positioned next to insulation layer 104 and will not sag, bunch, or otherwise move within heating unit 100. In particular, because insulation layer 104 is formed of a stiffer material than heating element 106, attaching heating element 106 to insulation layer 106 provides stiffness to heating element 106. While insulation layer 104 is referred to as being formed of a “stiffer” material, it will be appreciated that in some embodiments insulation layer 104 may still be somewhat flexible. Similarly, heat generating strip 114 and heat spreading element 122 can be attached to one another to ensure that heat generating strip 114 is properly positioned on heat spreading element 122, even after heating unit 100 is rolled, folded, and used several times. Likewise, heating element 106 and/or insulation layer 104 can be attached to first and/or second cover layers 102 and 108 to prevent the internal components of heating unit 100 from moving within first and second cover layers 102 and 108.

FIG. 2 illustrates one exemplary embodiment in which various components of heating unit 100 are attached together. In the embodiment illustrated in FIG. 2, there are three interfaces between the heating unit components for attachment between the components. Any, all, or none of the interfaces implement more secure attachment in various alternative embodiments. As used herein, an attachment interface is a surface where two or more components of heating unit 100 can be attached together. The first attachment interface 136 is between the top surface of insulation layer 104 and the bottom surface of heat spreading element 122. The second attachment interface 138 is between the top surface of heat spreading element 122 and the bottom surface of heat generating strip 114. The third attachment interface 140 is between the top surfaces of heat spreading element 122 and heat generating strip 114 and the bottom surface of second cover layer 108. In another embodiment, there is a fourth attachment interface between the bottom surface of insulation layer and the top surface of first cover layer 102.

Attachment interfaces 136, 138, and 140 can be created by attaching the above identified components of heating unit 100 in any suitable manner so that the components maintain their relative positions one to another. In one exemplary embodiment, attachment interfaces 136, 138, and 140 are created using an adhesive between the components of heating unit 100. One such adhesive suitable for attaching together the components of heating unit 100 is 30-NF FASTBOND™ available from 3M located in St. Paul, Minn. FASTBOND™ is a non-flammable, heat resistant, polychloroprene base adhesive.

To properly adhere the components of heating unit 100 together with FASTBOND™, the interfacing surfaces should be clean and dry. With the surfaces prepared, a uniform coat of FASTBOND™ is applied to both interfacing surfaces. After applying, the. FASTBOND™ is allowed to dry completely, which typically takes about 30 minutes. Once the FASTBOND™ on both surfaces is dry, the two FASTBOND™ coated surfaces are joined together.

For example, when attaching insulation layer 104 to heat spreading element 122, a coat of FASTBOND™ is applied to the top surface of insulation layer 104 and the bottom surface of heat spreading element 122. Once the FASTBOND™ on each surface is dry, heat spreading element 122 is positioned on top of insulation layer 104 and the two layers of FASTBOND™ adhere to one another. The same process can be followed to attach heat generating element 114 to the top surface of heat spreading element 122 and to attach second cover layer 108 to the top surfaces of heat generating element 114 and heat spreading element 122.

In the illustrated embodiment, second cover layer 108 is attached to heating element 106 and heating element is attached to insulation layer 104. Notably, insulation layer 104 is not attached to first cover layer 102. Not attaching insulation layer 104 to first cover layer 102 provides for flexibility and give in heating unit 100 when heating unit 100 is folded, rolled, or wrapped around an object. Specifically, heating unit 100 is configured to be wrapped around an object such that second cover layer 108 is adjacent the object and first cover layer 102 is positioned away from the object. When first cover layer 102 is not attached to insulation layer 104, first cover layer 102 is able to move relative to insulation layer 104 and stretch as heating unit 100 is wrapped around an object. In other embodiment, however, insulation layer 104 and first cover layer 102 are attached to one another. For example, when heating unit 100 is used where less flexibility is needed, the need for first cover layer 102 to be able to move relative to insulation layer 104 is not as great.

The following discussion will now treat additional details and embodiments of the various components of the heating module 100 of the heating unit 150. In some embodiments, the heating element 106 includes a heat generating element 114. The heat generating element 114 may be, for example, an electro-thermal coupling material or resistive element. In some embodiments, the heat generating strip may be a copper, copper alloy or other conductor. In one embodiment, and in particular embodiments where only the heating module 100 is actively heated by heaters internal to the heating module 100, the conductor is network of copper alloy elements configured to consume about 10 W of power per linear foot of the heat generating strip and to use about 58 feet of heat generating strip so as to draw a total of about 580 Watts, most of which is generated as heat. This may be achieved by selection of appropriate alloys for the heat generating element 114 in combination with selection of appropriate heat generating element wire sizes and circuit configurations. The conductor may convert electrical energy to heat energy, and transfer the heat energy to the surrounding environment. Alternatively, the heat generating element 114 may comprise another conductor, such as semiconductors, ceramic conductors, other composite conductors, etc., capable of converting electrical energy to heat energy. The heat generating element 114 may include one or more layers for electrical insulation, temperature regulation, and ruggedization. In an alternative embodiment where both the heating module 100 and the module 152 are actively heated by heaters internal to the modules, each of the modules may include 40 feet of heat generating strip so as to generate about 400 Watts of heat for each module for a total of 800 Watts for the entire heating unit 150. In particular, some embodiments sized 4 feet×4 feet×3 feet high may be designed to generate between about 550 and 800 Watts of heat. Other units sized 4 feet×4 feet×4 feet high may be designed to generate between about 600 and 1,000 Watts of heat.

Referring now to FIG. 2, the heat generating element 114 is illustrated with two heat generating conductors. One of the two conductors is connected to a first terminal of the incoming electrical connector 130 while the other conductor is connected to a second terminal of the electrical connector 130. The first and second terminals may be connected to electrical sources as appropriate, such as generator supplied AC or DC sources, batteries, power inverters, etc. The two conductors may be connected at one end to create a closed circuit allowing current to flow through the two conductors to generate heat.

The two conductors may be connected through a thermostat. In one embodiment, the thermostat includes a bi-metal strip based temperature control that disconnects the two conductors about a pre-determined temperature. Examples of predetermined temperatures may be between 70° F. to 100° F., and preferably operating at around 80° F. Notably, these are only examples, and other temperatures may be alternatively used. This can be used to regulate the temperature of the heating module 100 of the heating unit 150 to prevent overheating, or to maintain the temperature at a temperature of about the pre-determined temperature. Embodiments may be implemented where the temperature is determined by selecting a thermostat with a fixed temperature rating. Other embodiment may be implemented where the temperature setting of the thermostat can be adjusted to a predetermined temperature at manufacturing time. In some embodiments, the thermostat may be user accessible to allow a user to adjust the thermostat settings. While in the example illustrated the thermostat is located at the ends of the conductors of the heat generating element, it should be appreciated that in other embodiments the thermostat may be placed inline with one of the conductors. Additionally, some embodiments may include low voltage control circuitry including temperature control functionality, which controls application of power to the conductors to regulate temperature.

It should further be appreciated that embodiments may be implemented where other temperature or current protections are included. For example, embodiments may include magnetic and/or thermal circuit breakers, fuses, semiconductor based over-current protection, ground fault protection, arc fault protection, etc. In some embodiments, these may be located at the ends of the conductors or inline with one or more of the conductors as appropriate.

Temperature controls may be implemented using an additional temperature control. For example, FIG. 1 illustrates a temperature controller 170. The temperature controller 170 includes a receptacle 172 into which the plug 103(a) can be plugged. The temperature controller may include a plug 178 for receiving power, such as from an electrical outlet or other power source. The temperature controller 170 further includes a probe 174. The probe 174 may be placed inside of the heating unit 150 or directly into material stored in the heating unit 150. The probe 174 is connected to temperature sensing circuitry included as part of the temperature controller 170. In the example illustrated, the temperature controller includes a user interface 176 which allows a user to select one or more temperatures. In one embodiment, the temperature controller 170 includes a digital readout that allows a user to visually interact with the temperature controller 170. The digital readout may be user selectable to display temperatures in ° C., ° F., or ° K.

The temperature controller 170 may include comparison circuitry configured to compare user selected temperatures with sensed temperatures and to control power delivered to the plug 130(a) appropriately. For example, in one embodiment, the comparison circuitry may be coupled to a silicon control relay (SCR) or other switching device (such as a mechanical relay, transistor, etc.) that allows current to flow from a power source connected to the temperature controller plug 178 to the receptacle 172 and hence the plug 130(a) when a sensed temperature is within a predetermined range about a given temperature. When the temperature sensed by the sensing circuitry using the probe 174 exceeds range about the given temperature, the SCR or other switching device is opened so as to prevent current flow to the receptacle 172. For example, in one embodiment, a range may be selected that is 5° F. above and below a user selected given temperature. When a sensed temperature is 5° F. or more below the user selected given temperature, current is allowed to flow to the receptacle 172. When a sensed temperature is 5° F. or more above the user selected given temperature, current is not allow to flow to the receptacle 172. In one embodiment, the temperature controller may be configured to function between 80° F. and 200° F. In particular, the temperature controller 170 may allow a user to select temperatures in this range. This range is particularly useful in embodiments used to heat asphalt patch. In another embodiment, the temperature controller may be configured to function between 50° F. and 32° F. This embodiment may be particularly useful for warm soak applications to prevent freezing of material stored in the heating unit 150.

Controlling temperature may be accomplished by controlling the density of the heat generating element 114. This may be accomplished by controlling spacing between different portions of the heat generating element allowing for more or less material used for the heat generating element 114 to be included in the heating module 100 of the heating unit 150. This method may be especially useful when heat generating elements have a constant Wattage output per length of heat generating element. Thus a longer heat generating element 114 provides more heat than a shorter heat generating element 114.

The electrical heating element 106 may further include a heat spreading element. In general terms, the heat spreading element 122 is a layer of material capable of drawing heat from the heat generating element 114 and distributing the heat energy away from the heat generating element 114. Specifically, the heat spreading element 122 may comprise a metallic foil, wire mesh, carbon mesh, graphite, a composite material, or other material.

The heat-spreading element 122 in one embodiment is an electrically-conductive material comprising carbon. Graphite is one example of an electrically-conductive material comprising carbon. However, other suitable materials may include carbon-based powders, carbon fiber structures, or carbon composites. Those of skill in the art will recognize that material comprising carbon may further comprise other elements, whether they represent impurities or additives to provide the material with particular additional features. Materials comprising carbon may be suitable so long as they have sufficient thermal conductivity to act as a heat-spreading element. In one embodiment, the material comprising carbon comprises sufficient electrical conductivity to act as a ground connection, as will be discussed in more detail below. The heat-spreading element 122 may further comprise a carbon derivative, or a carbon allotrope.

One example of a material suitable for a heat spreading element 122 is a graphite-epoxy composite. The in-plane thermal conductivity of a graphite-epoxy composite material is approximately 370 watts per meter per Kelvin, while the out of plane thermal conductivity of the same material is 6.5 watts per meter per Kelvin. The thermal anisotropy of the graphite/epoxy composite material is then 57, meaning that heat is conducted 57 times more readily in the plane of the material than through the thickness of the material. This thermal anisotropy allows the heat to be readily spread out from the surface which in turn allows for more heat to be drawn out of the heating element 114.

The heat spreading element 122 may comprise a material that is thermally isotropic in one plane. The thermally isotropic material may distribute the heat energy more evenly and more efficiently. One such material suitable for forming the heat spreading element 122 is GRAFOIL® available from Graftech Inc. located in Lakewood, Ohio. In particular, GRAFOIL® is a flexible graphite sheet material made by taking particulate graphite flake and processing it through an intercalculation process using mineral acids. The flake is heated to volatilize the acids and expand the flake to many times its original size. The result is a sheet material that typically exceeds 98% carbon by weight. The sheets are flexible, lightweight, compressible resilient, chemically inert, fire safe, and stable under load and temperature. The sheet material typically includes one or more laminate sheets that provide structural integrity for the graphite sheet.

Due to its crystalline structure, GRAFOIL® is significantly more thermally conductive in the plane of the sheet than through the plane of the sheet. This superior thermal conductivity in the plane of the sheet allows temperatures to quickly reach equilibrium across the breadth of the sheet.

Typically, the GRAFOIL® will have no binder, resulting in a very low density, making the heated cover relatively light while maintaining the desired thermal conductivity properties.

Another product produced by GrafTech Inc. that is suitable for use as a heat spreading element 122 is eGraf® SpreaderShield™. The thermal conductivity of the SpreaderShield™ products ranges from 260 to 500 watts per meter per Kelvin within the plane of the material, and that the out of plane (through thickness) thermal conductivity ranges from 6.2 down to 2.7 watts per meter per Kelvin. The thermal anisotropy of the material ranges from 42 to 163. Consequently, a thermally anisotropic planar heat spreading element 122 serves as a conduit for the heat within the plane of the heat spreading element 122, and quickly distributes the heat more evenly over a greater surface area than a foil. The efficient planar heat spreading ability of the planar heat spreading element 122 also provides for a higher electrical efficiency, which facilitates the use of conventional power supply voltages such as 120 volts on circuits protected by 20 Amp breakers, instead of less accessible higher voltage power supplies. In some embodiments, the heat spreading element 122 is a planar thermal conductor. In certain embodiments, the graphite may be between 1 thousandths of an inch thick and 40 thousandths of an inch thick. This range may be used because within this thickness range the graphite remains pliable and durable enough to withstand repeated rolling and unrolling or folding and unfolding as the heating module 100 of the heating unit 150 is unrolled or unfolded for use and rolled or folded up for storage.

The heat spreading element 122 may comprise a flexible thermal conductor. In certain embodiments, the heat spreading element 122 is formed in strips along the length of the heat generating element 114. In alternative embodiments, the heat spreading element 122 may comprise a contiguous layer.

In some embodiments, the heat spreading element 122 may also include functionality for conducting electrical energy and converting electric energy to thermal energy in a substantially consistent manner throughout the heat spreading element. Graphite heat spreading elements may be particularly well suited for these embodiments. In such an embodiment, a heat generating element 114 may be omitted from the heating module 100 of the heating unit 150 as the heat spreading element 122 serves the purposes of conveying current, producing heat due to resistance, and evenly distributing the heat.

The small size and thickness of the graphite minimizes the weight of the heat spreading element 122. The graphite containing heat spreading element may be pliable such that the graphite can be rolled lengthwise without breaking the electrical path through the graphite.

In some embodiments, the heat spreading element 122 may include an insulating element formed of a thin plastic layer on both sides of the heat-spreading element 122. The insulating element may additionally provide structure to the heat-spreading material used in the heat spreading element 122. For example, the insulating element may be polyethylene terephthalate (PET) in the form of a thin plastic layer applied to both sides of a heat-spreading element 122 comprising graphite. Those of skill in the art will appreciate that such a configuration may result in the insulating element lending additional durability to the heat-spreading element 122 in addition to providing electrical insulation, such as electrical insulation from the electrical current in the heat generating element 114. It should be noted that the heating generating element 114 may include its own electrical insulation as well as described above.

In certain embodiments, the heat generating element 114 is in direct contact with the heat spreading element 122 to ensure efficient thermo-coupling. Alternatively, the heat spreading element 122 and the heat generating element 114 are integrally formed. For example, the heat spreading element 122 may be formed or molded around the heat generating element 114. Alternatively, heat generating element 114 and the heat spreading element 122 may be adhesively coupled.

Notably, while temperature may be controlled with the use of thermostats as described above, other embodiments may implement other design criteria to control temperature. For example, some embodiments may use appropriate selection of the heat spreading element 122 and/or the arrangement of the heat generating element 114. Illustratively, the heat retention properties of the heat spreading element 122 may be a factor in regulating temperatures at which a heating module 100 of the heating unit 150 will operate. Further, the density of the heat generating element 114 with respect to the size of the heating module 100 of the heating unit 150 or the heat spreading element 122 can be used set the operating temperatures or to regulate temperatures.

FIG. 2 illustrates an optional insulating layer 104. The insulating layer may be used to reflect or direct heat or to prevent heat from exiting in an undesired direction. For example, it may be desirable to have all or most of the generated heat be directed towards a particular surface of the heating module 100 of the heating unit 150. In particular, it is desirable to direct heat towards palleted material in the heating unit 150 while directing heat away from an exterior environment in which the pallet and heating unit 150 is located. In the example illustrated, it may be desirable to have heat directed towards the side of the heating module 100 of the heating unit 150 which includes the second cover layer 108, while directing heat away from the side that includes the first cover layer 102. The insulating layer 104 may be used to accomplish this task.

The insulating layer 104 may include a sheet of polystyrene, cotton batting, Gore-Tex®, fiberglass, foam rubber, etc. In one particular embodiment, the insulating layer includes a layer of closed cell foam. In certain embodiments, the insulating layer 104 may allow a portion of the heat generated by the heat generating element 114 to escape the outside of the second cover layer 108 if desired. For example, the insulating layer 104 may include a plurality of vents to transfer heat to the second cover layer 108. In certain embodiments, the insulating layer 104 may be integrated with either the first cover layer 102 or the second cover layer 108. For example, the first cover layer 102 may include an insulation fill or batting positioned between two films of nylon.

FIG. 2 further illustrates first and second cover layers 102 to 108. In some embodiments, first and second cover layers 102 to 108 may comprise a textile fabric. The textile fabric may include natural or synthetic products. For example, the first and second cover layers 102 to 108 may comprise burlap, canvas, cotton or other materials. In another example, first and second cover layers 102 to 108 may comprise nylon, vinyl, or other synthetic textile material. The first and second cover layers 102 to 108 may comprise a thin sheet of plastic, metal foil, polystyrene, or other materials.

In manufacturing the heating module 100 of the heating unit 150, the heating element 106 and insulation layer 104 may be sealed between the first and second cover layers 102 and 108. As illustrated in FIGS. 1 and 2, the first and second cover layers 102 and 108 extend slightly beyond the heating element 106 and insulation layer 104. This allows the first and second cover layers 102 and 108 to be sealed, such as be using an adhesive, heat welding, or another other appropriate method or combination of methods.

Additionally, the heating module 100 of the heating unit 150 may be constructed such that the first and second cover layers 102 and 108 may include one or more fasteners 160 (see FIG. 1) for hanging, securing, or connecting the heating module 100 of the heating unit 150. In some embodiments, the fasteners 160 may be attached or formed into the comers of the heating module 100 of the heating unit 150. Additionally, fasteners 160 may be distributed about portions of or the entire perimeter of the heating module 100 of the heating unit 150. In some embodiments, the fastener 160 is a hook and loop fastener such as Velcro®. For example, the heating module 100 of the heating unit 150 may include a hook fabric on one side and a loop fabric on an opposite side. In other alternative embodiments, the fastener 160 may include grommets, snaps, zippers, adhesives, or other fasteners. Further, additional objects may be used with the fasteners to accomplish fastening. For example, when grommets are used, elastic cord, such as bungee cord may be used to connect to grommets on opposite sides of the heating module 100 of the heating unit 150. In some embodiments, #5 grommets may be used.

The embodiment shown in FIGS. 1 and 2 includes a 7 foot power cord 166 connected to the heat generating element 114. Other cord lengths may also be implemented within the scope of embodiments of the invention. The power cord may additionally be to an incoming electrical connector 130 such as an AC power plug, bare wire connector, alligator clip connectors, a cigarette lighter plug connector or other appropriate connector for connecting the power cord to a source of power.

Notably, some embodiments may be implemented with interchangeable incoming electrical connectors. For example, embodiments may include a kit which includes a heating module 100 of the heating unit 150 with a two pin auto connector. The kit may further include a wire without an additional connector connected to a mating two pin auto connector, a set of alligator clips connected to a mating two pin auto connector, and a cigarette lighter plug connected to a mating two pin auto connector. A user can then select an appropriate incoming electrical connector. For example, a user may select the wire without an additional connector if the heating unit is to be hard wired to an electrical system, such as an automobile, boat, or other electrical system. Cigarette lighter plugs or alligator clip connectors could be selected for more temporary connectors.

Some embodiments may also include various fault protections. For example, embodiments may include an incoming electrical connector 110 which includes ground fault circuit interruption capabilities so as to make the heating module 100 of the heating unit 150 suitable for use in wet or outdoor environment. Embodiments may include over current protection such as breakers or fuses. Embodiments may include arc fault circuit interruption capabilities to address problems related to fatigue of wires or crushing of wires.

Embodiments may further include provisions for grounding the heating module 100 of the heating unit 150. For example, the heating unit is illustrated in FIG. 2 as including an incoming electrical connector 130 in the form an AC plug, which includes two power terminals and a grounding terminal. The power cord 166 may include three conductors, one connected to each power terminal of the incoming electrical conductor, and the third connected the grounding terminal. The two conductors connected each to a respective power terminal connect as described above to the heat generating element 114. The third conductor may be connected so as to ground the heating module 100 of the heating unit 150. This may be done, for example by including an electrically conductive layer (not shown) in the heating module 100 of the heating unit 150 which is electrically connected to the grounding terminal.

In an alternative embodiment, due to the electrically conductive nature of the heat spreading element 122 when a graphite based material is used for the heat spreading element 122, the grounding terminal may be electrically coupled to the heat spreading element 122. This may be accomplished in one example, by using a ground coupling in the form of a spade connector or other connector which passes through a protective layer of the heat spreading element so as to be in electrical contact with the conductive portions of the heat spreading element 122. In one embodiment, the ground couplings comprise planar rectangular metal connection blades that would normally be used as the hot and/or neutral connection blades of a power coupling such as a power coupling which connects to a power source. In one embodiment, ground coupling spade connector further comprises barbs configured to cut into the heat-spreading element 122 and engage the heat-spreading element 122 such that the blade does not come loose. In alternative embodiments, the blade may be connected to the heat-spreading element 122 with an adhesive that does not electrically insulate the heat-spreading element 122 from the blade. In addition, the plane of the blade may be placed parallel to the plane of the heat-spreading element 122 such that a maximum amount of the surface area of the blade is in direct contact with the heat-spreading element 122. Such a configuration may increase the contact area between the two surfaces and results in a better electrical and physical connection. Furthermore, such a configuration can leverage the lower in-plane resistivity of the heat-spreading element 122.

Additionally, some embodiments may include an outgoing electrical connector 132. This may be used, for example to allow chaining of modules and/or heating units together. In the example illustrated, the outgoing electrical connector 132 is connected electrically to the incoming electrical connector 130 through conductors passing through the heating module 100 of the heating unit 150. Other embodiments may allow the incoming electrical connector 130 and outgoing electrical connector 132 to be more or less proximate to each other as appropriate.

A grounding terminal of the outgoing electrical connector 132 may be electrically connected to the grounding terminal of the incoming electrical connector 130. This may be accomplished by wiring the two terminals together or connecting both grounding connectors to the same grounding surface, such as a grounding layer, or to the heat spreading element 122 as described above.

Some embodiments may further include timing circuitry such that a user can select when heating should occur. The timer may be an electronic controlled device supplied by the electrical connector 130 and may include internal switching such as relays or solid state switches for supplying power to the heat generating element 114.

Retuning once again to the description of FIG. 1, the second module 152 may be constructed in the same fashion as the heating module 100. Alternatively, the second module 152 may exclude certain elements, such as the entire heating element 106, or portions of the heating element 106 such as the heat generating element and the associated electrical connectors 130 and 132 and cords 166.

The lid module 154 may be fabricated in a fashion similar to the second panel 152. Namely, the lid module 154 may include all of the heating functionality of the heating module 100 or only insulating and or heat spreading functionality. In particular, some embodiments may be implemented where the lid module includes the heating element 106 along with the heat generating element 114 and heat spreading element 122. Alternatively, various elements may not be included in the lid module 154, including one or more of the heat generating element 114 and the heat spreading element 122. In some embodiments, the lid module 154 may be additionally insulated for better heat retention. For example, the lid module 154 may include double, triple, or some other ratio of insulation material in the insulation layer 104 as compared to the heating module 100. Further, the lid module 154 may include flaps 178. The flaps 178 can be secured to other portions of the heating unit 150 or otherwise arranged to prevent or inhibit wind from entering the heating unit 150. In one embodiment, the flaps 178 extend about six inches over other sides of the heating unit 150.

The lid module 154 may further include a crease 180 which allows a portion 182 of the lid module 154 to be lifted to allow for accessing the heating unit 150 from the top. Notably, in the example illustrated, the lid module 154 further includes the rods 156 and elbows 158 so as to provide a stiffening effect for lid module 154.

The heating unit, in one embodiment is sized to be about 4ft×4ft×3ft high so as to accommodate a standard 46 inch pallet and load stored thereon. In particular, this embodiment can store approximately 48 cubic feet internally. In an alternative embodiment, the heating unit 150 is sized to be about 4ft×4ft×4ft high. This embodiment has about 64 cubic feet of storage.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A heating unit for use in heating pallets, the heating unit comprising:
a first module, wherein the first module comprises:
a first pliable cover layer;
a second pliable cover layer coupled to the first pliable cover layer;
a first pliable electrical heating element disposed between the first and the second cover layers and configured to convert electrical energy to heat energy and to distribute the heat energy, the pliable electrical heating element comprising:
a first heat generating element for converting electrical current to heat energy; and
a first heat spreading element comprising carbon thermally coupled to the heat generating element;
a first thermal insulation layer positioned at one side of the oz pliable electrical heating element and between the first and the second cover layers;
a first receiving power connector electrically connected to the heat generating element, the receiving power connector configured to couple to an electrical power source;
a first plurality of support members arranged to provide rigidity to at least a portion of the first module; and
a first seam formed in the first module, the seam formed in a fashion that facilitates folding of the first module in a fashion which allows the support members to support the first module on an edge of the first module;
a second module, wherein the second module comprises:
a third pliable cover layer;
a fourth pliable cover layer coupled to the third pliable cover layer;
a second thermal insulation layer positioned between the third and the fourth cover layers;
a second plurality of support members arranged to provide rigidity to at least a portion of the second module; and
a second seam formed in the second module, the seam formed in a fashion that facilitates folding of the second module in a fashion which allows the support members to support the second module on an edge of the second module;
one or more fasteners coupled to or formed in at least one of the first, second, third, or fourth cover layers, and configured to allow the first and second modules to be connected in a fashion such that the first and second modules can be substantially arranged into the sides of a box; and
a cover module configured to cover the top of the box and to retain heat in the box.

2. The heating unit of claim 1, wherein the heating unit comprises a thermostat configured to regulate an operating temperature of the heating unit.

3. The heating unit of claim 2, wherein the thermostat is set at a predetermined temperature.

4. The heating unit of claim 2, wherein the thermostat is user adjustable.

5. The heating unit of claim 2, wherein the thermostat is incorporated in a temperature controller, wherein the temperature controller comprises:
a receptacle for receiving the first receiving power connector; and
a plug for electrically connecting the temperature controller to a power source.

6. The heating unit of claim 1, wherein the heating unit comprises a timer configured to control when the heating unit supplies heat energy.

7. The heating unit of claim 1, wherein the heat spreading element comprises graphite.

8. The heating unit of claim 1, wherein the heat spreading element is thermally isotropic in one plane.

9. The heating unit of claim 1, further comprising an outgoing electrical connector electrically coupled to the receiving power connecter, the outgoing electrical connector being configured to couple to receiving power connectors of other heating units.

10. The heating unit of claim 1, wherein the one or more fasteners comprise grommets.

11. The heating unit of claim 1, wherein the one or more fasteners comprise snaps with mating portions of the snaps disposed on opposing portions of the heating unit.

12. The heating unit of claim 1, wherein the cover module comprises flaps arranged to prevent or inhibit wind from entering the heating unit.

13. The heating unit of claim 1, wherein the second module comprises:
a second pliable electrical heating element disposed between the third and the fourth cover layers and configured to convert electrical energy to heat energy and to distribute the heat energy, the second pliable electrical heating element comprising:
a second heat generating element for converting electrical current to heat energy; and
a second heat spreading element comprising carbon thermally coupled to the heat generating element; and
a second receiving power connector electrically connected to the second heat generating element, the second receiving power connector configured to couple to an electrical power source.

14. The heating unit of claim 1, wherein the insulation layers comprise closed cell foam.

15. The heating unit of claim 1, wherein the cover layers comprise vinyl.

16. A method of heating a pallet and items stored on the pallet, the method comprising:
substantially surrounding the sides and top of the pallet and items stored on the pallet with a first pliable cover layer;
substantially covering at least a portion of the sides and top of the pallet and items stored on the pallet with a pliable heating element wherein the heating element comprises a heat generating element configured to convert electrical current to heat, and a heat spreading element comprising carbon configured to spread the heat from the heat generating element;
substantially surrounding the sides and top of the pallet and items stored on the pallet with a pliable insulation layer;
substantially surrounding the sides and top of the pallet and items stored on the pallet with a second pliable cover layer; and
supplying current to the heat generating element such that heat is spread by the heat spreading element to heat items stored on the pallet.

17. The method of claim 16, further comprising supporting the first pliable cover layer, the pliable heating element, the insulation layer and the second cover layer using an internal support structure surround by at least the first and second cover layers.

18. The method of claim 16, wherein substantially covering at least a portion of the sides and top of the pallet and items stored on the pallet with a pliable heating element comprises covering at least two sides of the pallet with the heat spreading element.

19. The method of claim 16, wherein substantially covering at least a portion of the sides and top of the pallet and items stored on the pallet with a pliable heating element comprises covering at least four sides of the pallet with the heat spreading element.

20. A method of manufacturing a pallet warmer, the method comprising:
constructing a first module, wherein constructing the first module comprises:
coupling a first pliable cover layer to a second pliable cover layer;
disposing a first pliable electrical heating element between the first and the second cover layers and configured to convert electrical energy to heat energy and to distribute the heat energy, the pliable electrical heating element comprising:
a first heat generating element for converting electrical current to heat energy; and
a first heat spreading element comprising carbon thermally coupled to the heat generating element;
disposing a first thermal insulation layer positioned at one side of the pliable electrical heating element between the first and the second cover layers;
coupling a first receiving power connector electrically to the heat generating element, the receiving power connector configured to couple to an electrical power source;
disposing a first plurality of support members between the first and second cover layers arranged to provide rigidity to at least a portion of the first module; and
forming a first seam formed in the first module, the seam formed in a fashion that facilitates folding of the first module in a fashion which allows the support members to support the first module on an edge of the first module;
constructing a second module, wherein constructing the second module comprises:
coupling a third pliable cover layer to a fourth pliable cover layer;
disposing a second thermal insulation layer between the third and the fourth cover layers;
disposing a second plurality of support members between the third and fourth cover layers arranged to provide rigidity to at least a portion of the second module; and
forming a second seam in the second module, the seam formed in a fashion that facilitates folding of the second module in a fashion which allows the support members to support the second module on an edge of the first module;
disposing or forming one or more fasteners in at least one of the first, second, third, or fourth cover layers, and configured to allow the first and second modules to be connected in a fashion such that the first and second modules can be substantially arranged into the sides of a box; and
constructing a cover module configured to cover the top of the box and to retain heat in the box.
